(19) United States
(12) Patent Application Publication
(10) Pub. No.: US 2003/0034282 A1
(43) Pub. Date: Feb. 20, 2003

(54) Method and system for generating background color for optical sorting apparatus

(75) Inventor: Morteza Safai, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: FMC Technologies, Inc.

(21) Appl. No.: 09/932,276

(22) Filed: Aug. 16, 2001

(51) Int. Cl. B07C 5/342

(52) U.S. Cl. 209/582

(57) ABSTRACT

A color sorting apparatus is provided, which defines a sorting area through which the products to be sorted pass. The apparatus includes: a background formed by a liquid crystal display (LCD) located adjacent to the sorting area; an optical sensor located across the sorting area from the background; and a processor coupled to the optical sensor. The optical sensor senses the radiation output from the background and the radiation reflected from and/or transmitted through the products passing through the sorting area, and generates a radiation signal indicative of the sensed radiation. The processor receives the radiation signal from the optical sensor, determines whether the received signal falls outside a predefined range of acceptable signals, and if so, identifies a portion of the products corresponding to the signal outside the predefined range. The apparatus may further include a feedback system to compensate for color/intensity drifting in the background during sorting operation.

### FIELD OF THE INVENTION

The present invention relates to a method and system for optically sorting objects, and more specifically, to a method and system for generating and adjusting the color of a background used in optical sorting.

### BACKGROUND OF THE INVENTION

Optical sorting apparatus are widely used in the food processing industry. In such apparatus, items being sorted, nuts, peas, or other food items, are propelled into the air from the end of a conveyor toward a collection chute. Monochromatic or color cameras inspect the products while “in flight.” Objects of a color beyond a satisfactory range are identified as rejects, and then redirected in flight using high-pressure air jets that are controlled based on the information generated by the cameras.

In an optical sorting apparatus, a background for the cameras is generated to match the desired color of acceptable items being sorted, so that any undesirable items in front of the background will be distinguishable to the cameras. Also, the intensity of such background light should be controlled because some cameras detect intensity-dependent values of colors, i.e., the cameras detect the same color having two different intensities as two different colors.

In the past, the desired background color was typically produced using complicated filter arrangements. One example of this prior method can be found in U.S. Pat. No. 5,265,732, which describes a variable-background device for use in an optical sorting apparatus. In this patent, the background device is formed of frosted glass for diffusing light, which is irradiated by two lamps that respectively produce long-wavelength radiation and short-wavelength radiation. Thus, the background device is suited for dichromatic sorting, wherein undesirable items are identified when they reflect an unacceptable amount of radiation in either of two radiation bands. U.S. Pat. Nos. 4,863,041 and 4,699,273 each describe a similar variable-background device including a filter arrangement for producing two desired wavelength radiations.

The prior art devices have several limitations. First, the color of food products that are processed in a color sorting machine changes from product to product. This creates a need for frequently and rapidly adjusting the background color so as to match it with the desired (acceptable) color of the products being processed. Adjustment of the background color using complex filter arrangements as required in the prior art devices is time-consuming and inefficient. Second, the background color and/or intensity often drift during operation due to various reasons, such as heating up of the background due to the intensity of a lamp used to illuminate the background, aging of the background or related components, or other reasons related to the internal electronics of the background or related components. When the background color/intensity drifts and becomes different from the acceptable color/intensity of the products being sorted, the background color/intensity causes false rejects of acceptable products. The prior art devices are not capable of addressing this problem.

Accordingly, a need exits for a background for use in a color sorting machine, which can easily and rapidly generate a desired color with desired uniform intensity. Preferably, the background should also be able to automatically adjust its color and intensity during operation to compensate for any color/intensity drifting.

### SUMMARY OF THE INVENTION

The present invention offers a color sorting apparatus for sorting products based on their colors, which defines a sorting area through which the products to be sorted can pass. The apparatus generally includes three components: a background formed by a liquid crystal display (LCD) located adjacent to the sorting area; an optical sensor located across the sorting area from the background; and a processor coupled to the optical sensor. The optical sensor is adapted to sense the radiation output from the background and the radiation reflected from and/or transmitted through the products passing through the sorting area, and then to generate a radiation signal indicative of the sensed radiation. The processor is controlled by computer-executable instructions for performing generally three steps. First, it receives the radiation signal from the optical sensor. Second, it determines whether the received radiation signal falls outside a predefined range of acceptable signals. Third, if the received radiation signal falls outside the predefined range, it identifies the portion of the products corresponding to the radiation signal determined to be outside the predefined range. The apparatus may further include a product separator, such as a high-pressure air jet, to separate the portion of the products identified as corresponding to the radiation signal outside the predefined range from the rest of the products.

The use of an LCD background is highly advantageous because the color of the LCD can be rapidly and accurately generated to match the desired color of acceptable products being sorted. Further, the intensity of the LCD background can be readily controlled. Any type of LCD may be used in accordance with the present invention, including both active and passive LCDs. Yet another advantage of using an LCD as the background is that its compactness and ease of handling permits arranging one or more LCDs in various configurations. For example, a plurality of sub-backgrounds, each formed by an LCD display, can be arranged 360 degrees around the sorting area to provide a 360-degree view of the products being sorted. In this case, a plurality of optical sub-sensors are provided, which are respectively located across the sorting area from the plurality of sub-backgrounds.

According to one aspect of the present invention, the optical sensor is a charge-coupled device (CCD) camera.

According to another aspect of the present invention, an LCD background may be replaced with other types of light-generating displays, such as a liquid-crystal-on silicon (LCoS) display and an organic light-emitting diode (OLED) display. An OLED display may be particularly advantageous in providing a 360-degree view of the products being sorted, because an OLED may be formed on a flexible substrate and thus may be rolled up into a generally cylindrical shape.

According to yet another aspect of the present invention, the color sorting apparatus of the present invention further includes a color feedback system configured to automatically adjust an input signal to the background so that the background's radiation output remains within a desired range. Therefore, even when the color or intensity of the background drifts during operation, the color feedback system automatically compensates for any affects of such color/intensity drifting. In one embodiment, the color feedback system includes a spectrometer configured and arranged to measure a color value of the radiation output from the background. The spectrometer is coupled to the processor, and the processor performs the following three steps. First, it receives the measured color/intensity value of the background from the spectrometer. Second, it references a predefined lookup table, which correlates a background input signal to an acceptable color/intensity value, to determine whether the received color/intensity value of the background equals the acceptable color/intensity value. Third, if the received color/intensity value does not equal the acceptable color/intensity value, the processor adjusts the input signal to the background until the measured color/intensity value of the background equals the acceptable color/intensity value in the lookup table. In one embodiment, the spectrometer is arranged to measure the radiation output from the background via a sensor (e.g., mirror) being arranged to scan the background.

According to still another aspect of the present invention, the color sorting apparatus further includes a rejection-rate feedback system configured to automatically maintain a rejection rate of the products being sorted at a predefined level. The term rejection rate refers to a rate at which the products being sorted are rejected (e.g., in a percentage). There are two approaches for maintaining the rejection rate substantially constant, which can be used independently or jointly. The first approach is to adjust an input signal to the background when the rejection rate is not at the predefined level until the desired rejection rate is achieved. This approach is effective in compensating for the affects of color/intensity drifting in the background, similarly to the color feedback system described above. The second approach is to modify the predefined range of acceptable signals to be received by the optical sensor, when the rejection rate is too high or too low, until the desired rejection rate is achieved. This approach is effective in sorting products when the acceptable color of the products shifts during operation. In other words, this approach compensates for the affects of color change in the products being sorted.

Both the color feedback system and the rejection-rate feedback system described above may be used with a background formed by an LCD, an LCoS display, OLED display, or the conventional cathode-ray-tube type of display.

The present invention also offers a method of sorting products based on their colors. The method includes four steps. First, a color sorting apparatus is provided, which defines a sorting area through which the products to be sorted can pass. The apparatus includes four components: a background formed of a light-generating display; an optical sensor; a color feedback system configured and arranged to measure a color/intensity value of the radiation output from the background; and a processor. Second, the products to be sorted are passed through the sorting area of the apparatus. Third, it is determined whether the radiation signal generated by the optical sensor falls outside a predefined range of acceptable signals, and if so, the portion of the products corresponding to the radiation signal outside the predefined range is identified. Fourth, it is determined whether the color/intensity value of the background measured by the feedback system equals a predefined acceptable color/intensity value, and if not, an input signal to the background is adjusted until the measured color/intensity value of the background equals the acceptable color/intensity value.

The present invention still further offers another method of sorting products based on their colors. The method includes four steps. First, a color sorting apparatus is provided, which defines a sorting area through which the products to be sorted pass. The apparatus includes three components: a background formed of a light-generating display; an optical sensor; and a processor. Second, the products to be sorted are passed through the sorting area of the apparatus. Third, it is determined whether the radiation signal generated by the optical sensor falls outside a predefined range of acceptable signals, and if so, the portion of the products corresponding to the radiation signal outside the predefined range is identified. Fourth, a rejection rate of the products is maintained at a predefined level. In one embodiment, the rejection rate is maintained by adjusting an input signal to the background. In another embodiment, the rejection rate is maintained by modifying the range of acceptable signals.

As will be apparent from the above summary, the present invention provides a color sorting apparatus and methods, including a background that allows for rapid generation of a desired color to match the acceptable color of the products to be sorted. The present invention also offers various embodiments of a feedback system, which can be used to compensate for the effects of color/intensity drifting in the background or color shift in the products during sorting operation. Therefore, the present invention offers highly advantageous and efficient apparatus and methods for color sorting.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a schematic representation of an embodiment of an apparatus and method for sorting products based on their colors in accordance with the present invention;

FIG. 2 illustrates a background for use in a color sorting apparatus, which is rolled to provide a 360 degree view of products being sorted;

FIG. 3 is a flowchart illustrating the operation of a color feedback system for automatically adjusting an input signal to a background used in a color sorting apparatus to maintain the radiation output from the background substantially constant; and

FIG. 4 is a flowchart illustrating the operation of a rejection-rate feedback system for automatically adjusting a color sorting apparatus to maintain the rejection rate of products being sorted at a predefined level.

### DETAILED DESCRIPTION OF THE PREFERRED EMBODIMENT

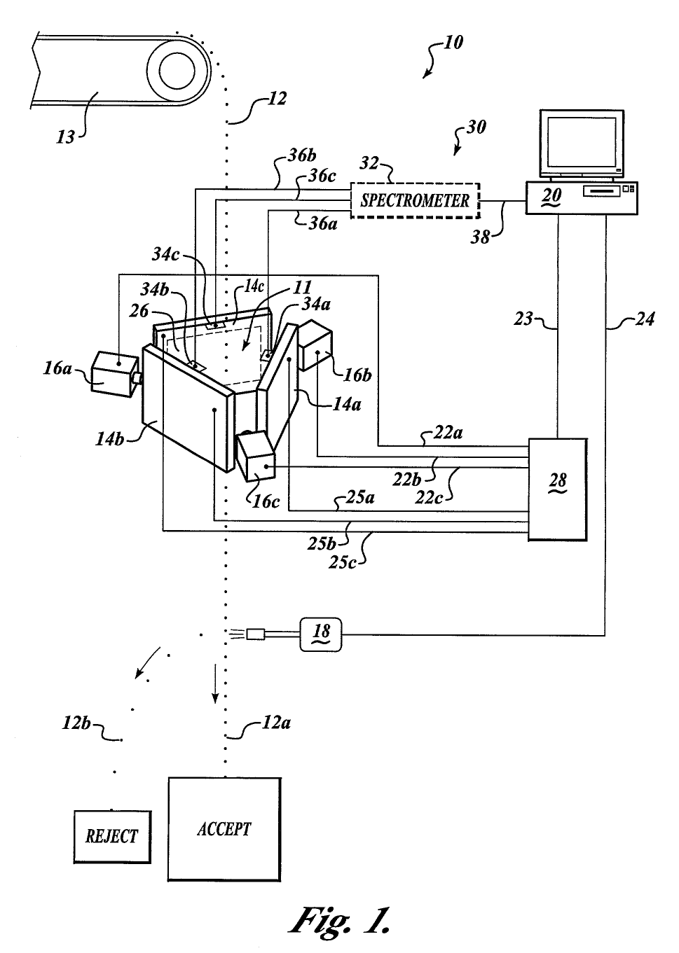

Referring to FIG. 1, the present invention offers a color sorting apparatus 10 suitable for sorting products based on their colors. While the following generally describes a sorting apparatus 10 of the present invention suited for sorting food items (nuts, peas, chips, etc.), the invention is not limited by the type of products to be sorted. In other words, an apparatus of the present invention may be readily adapted to sort various other products or material as long as they can be sorted based on their colors, for example, pills, nuts, bolts, powders, liquid, etc.

The apparatus 10 defines a sorting area 11 through which the products 12 to be sorted pass. Typically, the products 12 to be sorted are carried by a conveyor 13 and released (perhaps propelled) into the air from the end of the conveyor 13 toward the sorting area 11 of the apparatus 10. The apparatus 10 includes a background 14 formed by a liquid crystal display (LCD), which is located adjacent to the sorting area 11. In the illustrated embodiment, the background 14 consists of three sub-backgrounds 14A, 14B, and 14C, each formed by an LCD, which collectively surround the sorting area 11. This arrangement is advantageous in providing a 360-degree inspection view of the products 12 passing through the sorting area 11, as will be more fully described below. The apparatus 10 further includes an optical sensor 16 spaced from, for example located across the sorting area 11 from, the background 14. The optical sensor 16 is used to sense the radiation output from the background 14 and also the radiation either reflected from or transmitted through the products 12 passing through the sorting area 11. The optical sensor 16 then generates a radiation signal indicative of the sensed radiation. In the illustrated embodiment, the optical sensor 16 consists of three sub-sensors 16A, 16B, and 16C, which are located across the sorting area 11 from the plurality of sub-backgrounds 14A, 14B, and 14C, respectively. Each of the sub-sensors 16A, 16B, and 16C is configured to sense the radiation output from the sub-backgrounds 14A, 14B, and 14C and also the radiation reflected from and/or transmitted through the products 12 passing through the sorting area 11. Each of the optical sub-sensors 16A, 16B, and 16C then generates a radiation signal indicative of the sensed radiation. The apparatus 10 may further include a product separator 18 formed of, for example, a high-pressure air jet, for separating at least a portion of the products from the products 12 passing through the sorting area 11. Finally, the apparatus 10 includes a computer 20. The computer 20 is coupled to the optical sub-sensors 16A, 16B, and 16C via a bus line 23 and then lines 22A, 22B, and 22C, respectively. The computer 20 controls the operation of the product separator 18 via a line 24. In the illustrated embodiment, the computer 20 also controls the sub-backgrounds 14A, 14B, and 14C via bus line 23 and then lines 25A, 25B, and 25C, respectively, though the sub-backgrounds 14A, 14B, and 14C need not be coupled to the computer 20 in some applications.

In operation, as the products 12 to be sorted pass through the sorting area 11, the optical sensor 16 inspects the products 12. The products of the color beyond a predefined acceptable range are identified as rejects. To this end, the computer 20 receives the radiation signal from the optical sensor 16 and determines whether the received radiation signal falls outside a predefined range of acceptable signals. When the optical sensor 16 includes a plurality of sub-sensors, then the computer 20 receives the radiation signal from each of the sub-sensors and determines whether any of the received radiation signals falls outside the predefined range of acceptable signals. If so determined, the computer 20 identifies the portion of the products corresponding to the radiation signal determined to be outside the predefined range. When the color sorting apparatus 10 includes the product separator 18, the computer 20 further actuates the product separator 18 to separate the portion of the products identified as corresponding to the radiation signal outside the predefined range 12B from the rest of the products 12A. It should be noted that the term “color sorting” as used in the present description does not necessarily require physically separating products or portions thereof based on their colors, and may include merely identifying or spotting products or objects or portions thereof based on their predefined color characteristics.

In each application, the color of the LCD background 14 is generated to match the desired color of acceptable products being sorted, so that any unacceptable products will be distinguishable to the optical sensor 16 both from the acceptable products and the background 14. In this regard, the use of the LCD background 14 is highly advantageous because the color of the LCD can be readily and accurately set by merely controlling an input signal (e.g., numeric data input) to the LCD background 14. Thus, different background colors can be rapidly generated for sorting different products. Another advantage of using the LCD background 14 is that its intensity can be readily controlled. In this regard, it is noted that unlike prior background devices the LCD background can accurately generate a specific bandwidth of color, and therefore does not require extra intensity that would be required with the prior devices to compensate for imprecise color setting. Yet another advantage of using an LCD as the background 14 is that its compactness and ease of handling permits arranging one or more LCDs in various configurations to meet specific needs of each sorting application. For example, in many applications, it is desirable to inspect the products 12 passing through the sorting area 11 in a 360-degree view so that any defects on the products can be identified regardless of where (from which angle) the defects are visible on the products. To allow for inspection in a 360-degree view, a background must be provided 360 degrees around the sorting area 11. As illustrated in FIG. 1, a plurality of LCDs can be arranged to generally surround the sorting area 11 to provide the 360-degree view. While three LCDs are used in the illustrated embodiment, any number of LCDs may be used depending on each application. For example, two LCDs (and hence two optical sensors) may be arranged to generally face each other, or four LCDs (and hence four optical sensors) may be arranged in a generally square configuration.

The LCD may have any type or size of color dot pattern configuration. Examples of LCDs suitable for use in the present invention include any active or passive LCD, twisted nematic LCD, supertwisted nematic LCD, and plasma-addressed LCD.

In one embodiment, the apparatus 10 further includes a diffusing screen 26 placed on the surface of the LCD background 14 facing the sorting area 11. The diffusing screen 26 serves to diffuse the LCD output more evenly to achieve uniform intensity and also to eliminate false rejects of acceptable products caused from speckles or graininess of the LCD. An example of material suitable for forming the diffusing screen 26 is a holographic screen. Additionally or alternatively, in order to reduce the speckle/graininess problem with the LCD, the optical sensor 16 may be set to view the background 14 out-of-focus, which is a well known technique used in the art.

The optical sensor 16 of the apparatus 10 may be any monochromatic or color cameras that can detect colors (hues). In one embodiment, the optical sensor 16 is formed of a charge-coupled device (CCD) camera. As known in the art, a CCD camera may include a 2D area sensor based on a matrix of CCDs, or may include an ID line sensor based on an array of CCDs. Typically, an ID line sensor includes more pixels than a 2D area sensor along the same direction, and thus has higher resolution, though it of course has to be repeatedly scanned to obtain a 2D image. Therefore, as used in the present description, the term “CCD camera” encompasses both 1D line sensor and 2D area sensor.

Optionally, the raster speed of the LCD background 14 may be synchronized with the line scan speed of the optical sensor 16 so as to avoid aliasing, i.e., to prevent display-refreshing “lines” from appearing on an image view of the optical sensor 16. This can be accomplished by providing a synchronizing circuit, contained in a circuit box 28 in the illustrated embodiment, which is configured to refresh both the LCD background 14 and the optical sensor 16 in synchronization. The configuration of a synchronizing circuit is well known in the art and therefore is not described in detail. In the illustrated embodiment, the synchronizing circuit controls the raster speed of the three sub-backgrounds 14A, 14B, and 14C via the lines 25A, 25B, and 25C and the line scan speed of the optical sub-sensors 16A, 16B, and 16C via the lines 22A, 22B, and 22C, respectively.

The computer 20 includes a central processing unit (CPU), a memory, and a user interface, as well known in the art. Collectively, these elements will process the radiation signal received by the optical sensor 16 to identify unacceptable products, while also controlling the operation of various components of the apparatus 10 coupled to the computer 20, such as the background 14, optical sensor 16, and product separator 18. As will be apparent to those skilled in the art, any processing or controlling operation may be performed by a single computer, or by a plurality of networked computers in a distributed manner, and the term “computer 20” is used herein to cover various arrangements of one or more computers.

In the foregoing description, the configuration and advantages of a sorting apparatus including an LCD background have been discussed. The present invention also provides the use of other types of light-generating displays to form a background in a color sorting apparatus. Two examples of such displays suited for forming a background are a liquid-crystal-on-silicon (LCoS) display and an organic light-emitting diode (OLED) display. Both LCoS displays and OLED displays can rapidly generate a wide range of colors, and therefore are well suited for forming a background to sort different products having different colors. In both embodiments, the rest of the configuration and operation of the color sorting apparatus 10 may be essentially the same as described above, and therefore are not repeated.

Both LCoS displays and OLED displays are relatively new technologies, though their constructions and operations are known among those skilled in the art. Briefly, LCoS displays are based on a reflective technology. The basic structure of an LCoS display consists of a liquid-crystal layer sitting on a silicon chip, and a first common electrode and a plurality of second electrodes that are arranged to generally sandwich the liquid-crystal layer, wherein each of the second electrodes also acts as a reflective mirror at each memory site (pixel). One advantage of using an LCoS display to form a background in a color sorting apparatus of the present invention is that an LCoS display background can produce very intensive light. In general, greater intensity of the background is better for color sorting purposes because the products being sorted will be more uniformly illuminated and also because the effects of the sorting area getting dusty or decrease in the ambient light level will be minimized.

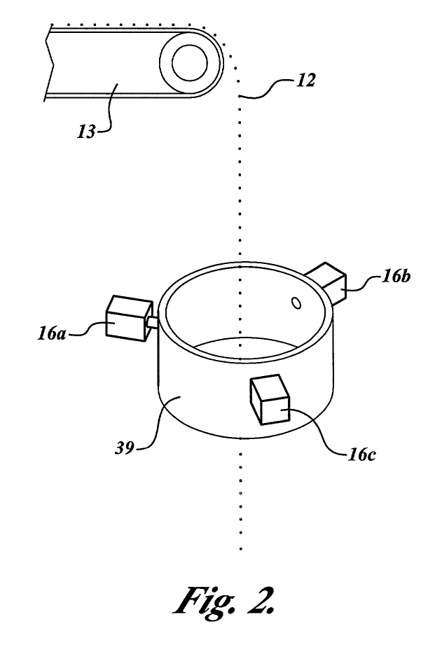

OLED displays are based on an emissive technology. The basic structure of an OLED display consists of two layers of organic thin films—a hole transport layer and an electron transport layer—that are sandwiched between an anode and a cathode, wherein organic instead of inorganic semiconductors are used in a manner similar to a conventional p-n diode. One advantage of an OLED display is that it can yield intensive brightness using only a low-drive voltage. Another advantage of an OLED display is that it can be formed not only on a rigid substrate (e.g., glass) but also on a flexible substrate (e.g., plastic). Accordingly, referring to FIG. 2, a flexible OLED display (or a combination of a plurality of flexible OLED displays) can be rolled up to form a background 39 in a generally curved or cylindrical shape to provide a truly 360-degree view for the color sorting apparatus 10.

As described in the background section, the color/intensity of a background often drifts during color sorting operation due to heating or aging of the background or other reasons related to the internal electronics of the background or related components. A background of the present invention formed by an LCD, LCoS, or OLED is also subject to the color/intensity drifting limitation. To mitigate the effect of color/intensity drifting, though, the present invention offers a several embodiments of a feedback system to be incorporated in the color sorting apparatus. While the following generally describes various embodiments of a feedback system as used in connection with an LCD background, it should be understood by those skilled in the art that these feedback systems can be used equally well with a background formed of an LCoS display, an OLED display, or a conventional cathode-ray-tube type of display.

Referring back to FIG. 1, the first embodiment of a feedback system is a color feedback system 30 that is configured to automatically adjust an input signal to the background 14 so that the background's radiation output remains substantially constant in terms of both color and also (optionally) intensity. In other words, the color feedback system 30 is adapted to constantly compensate for any effects of the color/intensity drifting in the background. In the illustrated embodiment, the color feedback system 30 includes a spectrometer 32 configured and arranged to measure a color value, i.e., a wavelength value, and also an intensity value of the radiation output from the background 14. To this end, in the illustrated embodiment, three rotating mirrors 34A, 34B, and 34C are arranged to respectively scan the radiation output of the three sub-backgrounds 14A, 14B, and 14C. The radiations scanned by the rotating mirrors 34A, 34B, and 34C are then sent to the spectrometer 32 via lines 36A, 36B, and 36C, respectively. The spectrometer 32 analyzes the received radiations to measure the color value and intensity value of each radiation output from the sub-background 14A, 14B, or 14C. The color values and intensity values of the radiations from the sub-backgrounds 14A, 14B, and 14C are then sent to the computer 20 via a bus line 38 for further processing.

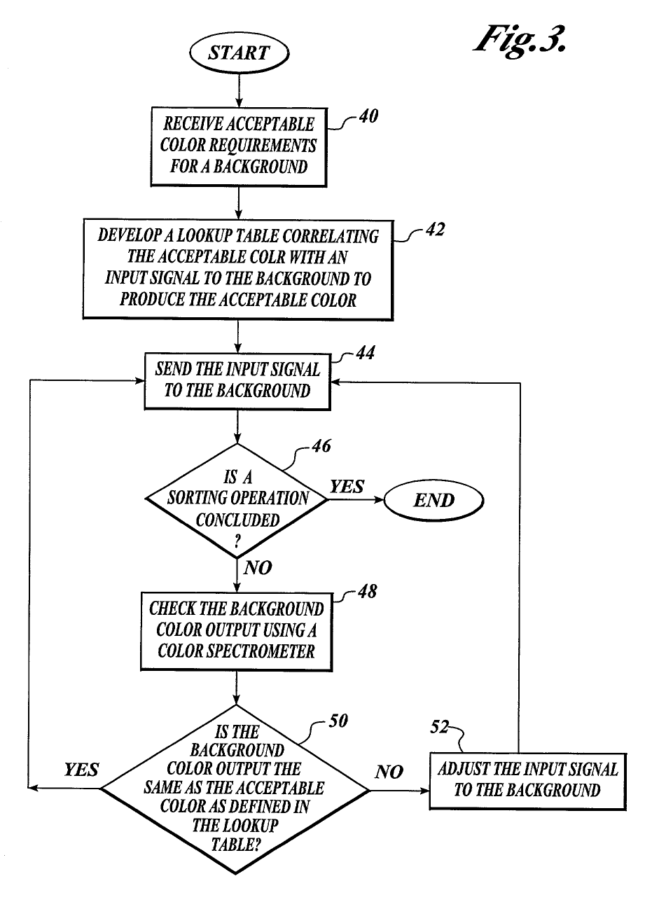

Referring additionally to FIG. 3, the operation of the color feedback system 30 is described in detail. In block 40, prior to sorting products using the color sorting apparatus 10 of the present invention, the computer 20 receives acceptable color and intensity requirements for the background 14 from an operator. This is typically accomplished by an operator entering the requirements for a color (hue) to be displayed on the background 14, which should be the same as the color of acceptable products to be sorted. The operator also enters the intensity requirements for the particular operation. In block 42, the computer 20 develops a lookup table that correlates the acceptable color/intensity specified by the operator with an input signal to the background 14 selected to generate the acceptable color/intensity on the background 14. For example, in a lookup table, input signal X is defined to produce color “red” at a certain intensity level on the background 14, input signal Y is defined to produce color “green” at a certain intensity level on the background 14, and so forth. The lookup table may grow each time an operator enters and stores new color/intensity requirements for the background 14 for sorting new products, which requirements can be later retrieved for sorting the same products. It should be appreciated that the lookup table may be stored in software to be loaded onto the computer 20, or hardware (the computer 20 itself), depending on each application.

Once the lookup table is defined, next in block 44, the input signal defined in the lookup table to produce the acceptable color/intensity on the background 14 is sent to the background 14, typically via a video graphics array (VGA). Next, in block 46, it is determined whether the present sorting operation is concluded. This occurs when, for example, all the products to be sorted have been sorted, or the operator indicates that the sorting operation is to be terminated. If so, the operation ends. If not, proceeding to block 48, the computer 20 checks the color output from the LCD background 14 using the spectrometer 32. Specifically, in the embodiment of FIG. 1, the computer 20 receives the color values and intensity values of the sub-backgrounds 14A, 14B, and 14C from the spectrometer 32. Then, in block 50, the computer 20 determines whether the received color value and intensity value of the background 14 equal the acceptable color value and intensity value as defined in the lookup table. In the illustrated embodiment, the computer 20 determines whether the received color value and intensity value of each of the sub-backgrounds 14A, 14B, and 14C equals the acceptable color value and intensity value that the input signal to each of these sub-backgrounds is supposed to generate. If so, the process returns to block 44 to send the same input signal to the background 14 and continues the loop including blocks 44, 46, 48, and 50 until the sorting operation is concluded in block 46.

On the other hand, if in block 50 it is determined that the background color and/or intensity output is not the same as the acceptable color and/or intensity defined in the lookup table, proceeding to block 52, the computer 20 adjusts the input signal to the background 14 so that the adjusted input signal will produce the acceptable color and/or intensity. To this end, the computer 20 may be an intelligent computer color processor, which is capable of controlling the input signal to the LCD background 14 by adjusting various parameters of the input signal according to the predefined lookup table. For example, when the acceptable color is “purple” but the color output from the background 14 is determined to be “red”, the computer 20 may add or increase “blue” parameter of the input signal to the background 14 to thereby produce purple color on the background 14. Returning to block 44, the adjusted signal is then input to the background 14. If the adjusted input signal does not achieve the desired color/intensity output, the process repeats the loop including blocks 44, 46, 48, 50, and 52 until the desired color/intensity output is generated on the background 14 as determined in block 50, or until the sorting operation is concluded in block 46.

While the embodiment described above employed the spectrometer 32 to measure the color value and intensity value of the background 14, it should be understood that the use of spectrometer 32 is not necessary. For example, a typical color CCD camera includes a dichromatic prism arrangement for separating any received color into three tristimulus components (e.g., Red, Green, and Blue). A CCD camera also includes three sensors for detecting the three separated color components and their intensity levels, respectively. Therefore, the CCD camera (16A-16C) itself may be used to perform the function of measuring the color value and intensity value of the background 14 as part of the color feedback system, though its color resolution may be not as high as that of a high-performance spectrometer.

The second embodiment of a feedback system in accordance with the present invention is a rejection-rate feedback system, which is configured to maintain a rejection rate of the products being sorted at a predefined level during sorting operation. The term “rejection rate” means a rate at which the products being sorted are rejected. For example, the rejection rate may be expressed as a frequency at which the radiation signal received by the optical sensor 16 is determined to fall outside the predefined range of acceptable signals, i.e., a frequency at which “rejects” are found in the products being sorted (the number of times the “rejects” are identified per unit time). In another form, the rejection rate may be expressed as a ratio of the products that are rejected (in a percentage). Obviously, the rejection rate may be expressed in various forms and units, and therefore the term as used in the present description is not limited to any one form.

There are generally two ways to maintain the rejection rate of products constant during sorting operation. First, one may adjust an input signal to the background 14 to maintain the rejection rate constant. This approach is effective in compensating for any effects of color/intensity drifting in the background 14. Specifically, when the background color/intensity drifts and becomes different from the acceptable color of the products being sorted, the background itself is falsely recognized as “rejects” to thereby cause an increase in the rejection rate. Thus, adjusting an input signal to the background, and hence adjusting the color/intensity output from the background, to maintain the rejection rate constant in turn (or indirectly) compensates for any color/intensity drifting in the background 14. Second, in order to maintain the rejection rate constant, one may also adjust the range of acceptable signals to be received by the optical sensor 16 for recognizing acceptable products. This approach is effective in sorting products when the acceptable color of the products shifts during operation. For example, when sorting a relatively large quantity of the same products, the acceptable color (hue) of the products may vary somewhat from the beginning to the end. Because the range of acceptable signals is typically defined based on the acceptable color of the products at the beginning of sorting operation, the range may be defined too “tight” for the products to be sorted later in the same sorting operation. Consequently, toward the end of the sorting operation, even acceptable products may be falsely recognized as “rejects” to thereby cause an increase in the rejection rate. Likewise, if the range of acceptable signals is defined too broadly for the products to be sorted later in a sorting operation, even “rejects” will be falsely recognized as acceptable toward the end of the sorting operation to thereby cause a decrease in the rejection rate. These problems can be mitigated by modifying (e.g., broadening or narrowing) the range of acceptable signals so as to maintain the rejection rate constant.

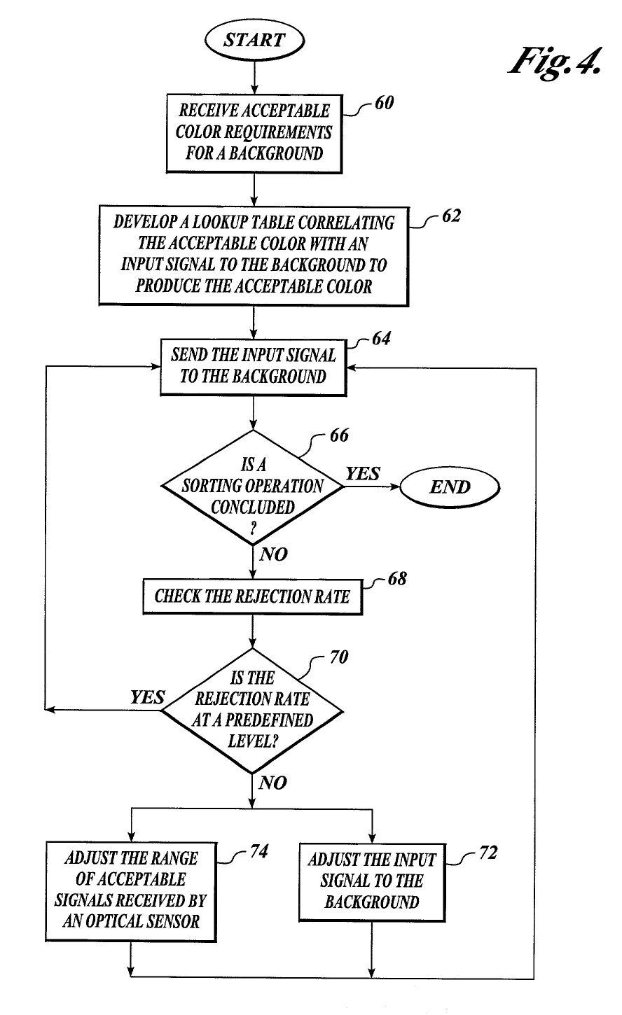

Specifically, the operation of the rejection-rate feedback system is described in reference to FIG. 4. The first four blocks in FIG. 4 are the same as the first four blocks in FIG. 3 described above. Specifically, in block 60, the computer 20 receives acceptable color and intensity requirements for the background 14 from an operator, and in block 62, the computer 20 develops a lookup table that correlates the acceptable color and intensity with an input signal to the background 14 selected to generate the acceptable color and intensity on the background 14. In block 64, the computer 20 sends this input signal to the background 14. In block 66, it is determined whether the present sorting operation is to be concluded. If so, the operation ends.

On the other hand, if the sorting operation is to continue, the computer 20 proceeds to the next block 68 and checks the rejection rate of the products being sorted. To this end, it is contemplated that the rejection rate is constantly calculated and stored in the computer, as will be apparent to those skilled in the art. Next, in block 70, it is determined whether the rejection rate of the products being sorted is at a predefined level. For example, when the rejection rate is expressed as a percentage of the products being rejected, it is determined whether the rejection rate is, for example, above 0.1% and/or below 3%. Typically, the rejection rate should not be either too low or too high. Thus, the “predefined level” as used in the present description may refer to not only a particular level, but also a range of levels at which the rejection rate should be. If it is determined that the rejection rate is at the predefined level, the process returns to block 64 to send the same input signal to the background 14 and continues the loop including blocks 64, 66, 68, and 70 until the sorting operation is concluded in block 66. On the other hand, if in block 70 it is determined that the rejection rate is not at the predefined level, a process necessary to correct the rejection rate is performed.

As described above, there are basically two ways to maintain the rejection rate at a predefined level. First, referring to block 72, the computer 20 may adjust the input signal to the background 14 so as to decrease or increase the rejection rate until the rejection rate reaches the predefined level. This may be a trial-and-error type of process, with the computer 20 adjusting the input signal to the background 14 in one direction along the color spectrum to see if it will achieve a desired change in the rejection rate, and if not, adjusting the input signal in the opposite direction along the color spectrum. Specifically, returning to block 64, the adjusted signal is input to the background 14. If the adjusted input signal does not achieve the desired rejection rate, the process repeats the loop including blocks 64, 66, 68, 70, and 72 until the desired rejection rate is achieved as determined in block 70, or until the sorting operation is concluded in block 66. Of course, if the direction or tendency of color/intensity drifting in the background 14 is known, such knowledge can be used to intelligently adjust the input signal in block 72.

Second, referring to block 74, the computer 20 may adjust the predefined range of acceptable signals to be received by the optical sensor 16 so as to decrease or increase the rejection rate until the rejection rate reaches the predefined level. For example, if the rejection rate is too high, the computer 20 changes or broadens the range of acceptable signals, and if the rejection rate is too low, the computer 20 changes or narrows the range of acceptable signals. This may also be a trial-and-error type of process, with the computer 20 incrementally broadening or narrowing the range of acceptable signals until the desired rejection rate is achieved. Specifically, after the range of acceptable signals is adjusted in block 74, returning to block 64, the same input signal is input to the background 14. If the desired rejection rate is not achieved, the process repeats the loop including blocks 64, 66, 68, 70, and 74 until the desired rejection rate is achieved as determined in block 70, or until the sorting operation is concluded in block 66. It is noted that the acceptable signal adjustment in block 74 may be performed independently of or jointly with the background input signal adjustment in block 72. In some applications, it may be desirable to adjust both the input signal to the background 14 and the range of acceptable signals to be received by the optical sensor 16 to achieve a more precise color sorting.

As noted above, various embodiments of a feedback system of the present invention described above may be used in connection with any type of background for use in a color sorting apparatus. Specifically, a feedback system of the present invention may be used in conjunction with not only an LCD display, but also with an LCoS display, an OLED display, or a conventional cathode-ray-tube type of display.

While several embodiments of the invention have been illustrated and described, it will be appreciated that various changes can be made therein without departing from the spirit and scope of the invention.

The embodiments of the invention in which an exclusive property or privilege is claimed are defined as follows:

1. A color sorting apparatus for sorting products based on their colors, the apparatus defining a sorting area through which the products to be sorted pass, the apparatus comprising:
(a) a background comprising a liquid crystal display, the background being located adjacent to the sorting area;
(b) an optical sensor spaced from the background for sensing the radiation output from the background and the radiation reflected from and/or transmitted through the products passing through the sorting area, and for generating a radiation signal indicative of the sensed radiation;
(c) a processor coupled to the optical sensor; and
(d) computer-executable instructions for the processor for performing the steps of:
(i) receiving the radiation signal from the optical sensor,
(ii) determining whether the received radiation signal falls outside a predefined range of acceptable signals, and
(iii) if the received radiation signal falls outside the predefined range, identifying the portion of the products corresponding to the radiation signal determined to be outside the predefined range.

2. The apparatus of claim 1, further comprising:
a product separator for separating at least a portion of the products from the products passing through the sorting area, the product separator being coupled to the processor; and
computer-executable instructions for the processor for performing the step of actuating the product separator to separate a portion of the products identified as corresponding to the radiation signal determined to be outside the predefined range from the rest of the products.

3. The apparatus of claim 1, wherein the background comprises a display selected from the group consisting of an active matrix liquid crystal display (AMLCD); a passive liquid crystal display; a twisted nematic liquid crystal display; a supertwisted nematic liquid crystal display; and a plasma-addressed liquid crystal display.

4. The apparatus of claim 3, wherein the background surrounds the sorting area 360 degrees around.

5. The apparatus of claim 4, wherein the background consists of a plurality of sub-backgrounds each comprising a liquid crystal display, and the optical sensor consists of a plurality of sub-sensors each being located across the sorting area from the plurality of sub-backgrounds, respectively, for sensing the radiation output from the sub-backgrounds and the radiation reflected from and/or transmitted through the products passing through the sorting area and for generating a radiation signal indicative of the sensed radiation, the processor being coupled to the optical sub-sensors and controlled by computer-executable instructions for performing the steps of:
(i) receiving the radiation signal from each of the optical sub-sensors,
(ii) determining whether the received radiation signal falls outside a predefined range of acceptable signals, and
(iii) if any received radiation signal falls outside the predefined range, identifying the portion of the products corresponding to the radiation signal determined to be outside the predefined range.

6. The apparatus of claim 1, wherein the background surrounds the sorting area.

7. The apparatus of claim 1, wherein the optical sensor comprises a charge-coupled device (CCD) camera.

8. The apparatus of claim 1, wherein the background further comprises a diffusing screen placed on a surface of the liquid crystal display facing the optical sensor.

9. The apparatus of claim 1, wherein the processor is further coupled to the background for controlling an input signal thereto, and the apparatus further comprises:
a feedback system configured to automatically adjust an input signal to the background so that the background's radiation output remains within a desired range.

10. The apparatus of claim 9, wherein the feedback system comprises a spectrometer being configured and arranged to measure a color value of the radiation output from the background, the spectrometer being coupled to the processor, and the processor being controlled by computer-executable instructions for performing the steps of:
(i) receiving the measured color value from the spectrometer,
(ii) referencing a predefined lookup table, which correlates a background input signal to an acceptable color value, to determine whether the received color value of the background equals the acceptable color value, and
(iii) if the received color value does not equal the acceptable color value, adjusting the input signal to the background until the measured color value of the background equals the acceptable color value in the lookup table.

11. The apparatus of claim 10, wherein the spectrometer is further configured to measure an intensity value of the radiation output from the background, and the processor is controlled by computer-executable instructions for performing the further steps of:
(iv) receiving the measured intensity value from the spectrometer,
(v) referencing the predefined lookup table, which correlates a background input signal to an acceptable intensity value, to determine whether the received intensity value of the background equals the acceptable intensity value, and
(vi) if the received intensity value does not equal the acceptable intensity value, adjusting the input signal to the background until the measured intensity value of the background equals the acceptable intensity value in the lookup table.

12. The apparatus of claim 10, wherein the spectrometer is arranged to measure the radiation output from the background via a sensor being arranged to scan the background.

13. The apparatus of claim 9, wherein the optical sensor comprises a charge-coupled device (CCD) camera, and the feedback system comprises the CCD camera being further configured and arranged to measure a color value and an intensity value of the radiation output from the background.

14. The apparatus of claim 1, wherein the processor is controlled by computer-executable instructions for performing the step of maintaining a rejection rate of the products at a predefined level.

15. The apparatus of claim 14, wherein the processor is further coupled to the background for controlling an input signal thereto, and the step of maintaining a rejection rate of the products comprises the processor adjusting an input signal to the background when the rejection rate is not at the predefined level until the rejection rate is at the predefined level.

16. The apparatus of claim 14, wherein the step of maintaining a rejection rate of the products comprises the processor modifying the range of acceptable signals when the rejection rate is not at the predefined level until the rejection rate is at the predefined level.

17. A color sorting apparatus for sorting products based on their colors, the apparatus defining a sorting area through which the products to be sorted pass, the apparatus comprising:
(a) a background comprising a Liquid-Crystal-on-Silicon (LCoS) display, the background being located adjacent to the sorting area;
(b) an optical sensor spaced from the background for sensing the radiation output from the background and the radiation reflected from and/or transmitted through the products passing through the sorting area, and for generating a radiation signal indicative of the sensed radiation;
(c) a processor coupled to the optical sensor; and
(d) computer-executable instructions for the processor for performing the steps of:
(i) receiving the radiation signal from the optical sensor,
(ii) determining whether the received radiation signal falls outside a predefined range of acceptable signals, and
(iii) if the received radiation signal falls outside the predefined range, identifying the portion of the products corresponding to the radiation signal determined to be outside the predefined range.

18. The apparatus of claim 17, further comprising:
a product separator for separating at least a portion of the products from the products passing through the sorting area; and
computer-executable instructions for the processor for performing the step of actuating the product separator to separate a portion of the products identified as corresponding to the radiation signal determined to be outside the predefined range from the rest of the products.

19. The apparatus of claim 17, wherein the background surrounds the sorting area 360 degrees around.

20. The apparatus of claim 19, wherein the background consists of a plurality of sub-backgrounds each comprising a Liquid-Crystal-on-Silicon (LCoS) display, and the optical sensor consists of a plurality of sub-sensors each being located across the sorting area from the plurality of sub-backgrounds, respectively, for sensing the radiation output from the sub-backgrounds and the radiation reflected from and/or transmitted through the products passing through the sorting area and for generating a radiation signal indicative of the sensed radiation, the processor being coupled to the optical sub-sensors and controlled by computer-executable instructions for performing the steps of:
(i) receiving the radiation signal from each of the optical sub-sensors,
(ii) determining whether the received radiation signal falls outside a predefined range of acceptable signals, and
(iii) if any received radiation signal falls outside the predefined range, identifying the portion of the products corresponding to the radiation signal determined to be outside the predefined range.

21. The apparatus of claim 17, wherein the background surrounds the sorting area.

22. The apparatus of claim 17, wherein the optical sensor comprises a charge-coupled device (CCD) camera.

23. The apparatus of claim 17, wherein the background further comprises a diffusing screen placed on a surface of the display facing the optical sensor.

24. The apparatus of claim 17 wherein the processor is further coupled to the background for controlling an input signal thereto, and the apparatus further comprises:
a feedback system configured to automatically adjust an input signal to the background so that the background's radiation output remains within a desired range.

25. The apparatus of claim 24, wherein the feedback system comprises a spectrometer being configured and arranged to measure a color value of the radiation output from the background, the spectrometer being coupled to the processor, and the processor being controlled by computer-executable instructions for performing the steps of:
(i) receiving the measured color value from the spectrometer,
(ii) referencing a predefined lookup table, which correlates a background input signal to an acceptable color value, to determine whether the received color value of the background equals the acceptable color value, and
(iii) if the received color value does not equal the acceptable color value, adjusting the input signal to the background until the measured color value of the background equals the acceptable color value in the lookup table.

26. The apparatus of claim 25, wherein the spectrometer is further configured to measure an intensity value of the radiation output from the background, and the processor is controlled by computer-executable instructions for performing the further steps of:
(iv) receiving the measured intensity value from the spectrometer,
(v) referencing the predefined lookup table, which correlates a background input signal to an acceptable intensity value, to determine whether the received intensity value of the background equals the acceptable intensity value, and
(vi) if the received intensity value does not equal the acceptable intensity value, adjusting the input signal to the background until the measured intensity value of the background equals the acceptable intensity value in the lookup table.

27. The apparatus of claim 25, wherein the spectrometer is arranged to measure the radiation output from the background via a sensor being arranged to scan the background.

28. The apparatus of claim 24, wherein the optical sensor comprises a charge-coupled device (CCD) camera, and the feedback system comprises the CCD camera being further configured and arranged to measure a color value and an intensity value of the radiation output from the background.

29. The apparatus of claim 17, wherein the processor is further controlled by computer-executable instructions for performing the step of maintaining a rejection rate of the products at a predefined level.

30. The apparatus of claim 29, wherein the processor is further coupled to the background for controlling an input signal thereto, and the step of maintaining a rejection rate of the products comprises the processor adjusting an input signal to the background when the rejection rate is not at the predefined level until the rejection rate is at the predefined level.

31. The apparatus of claim 29, wherein the step of maintaining a rejection rate of the products comprises the processor modifying the range of acceptable signals when the rejection rate is not at the predefined level until the rejection rate is at the predefined level.

32. A color sorting apparatus for sorting products based on their colors, the apparatus defining a sorting area through which the products to be sorted pass, the apparatus comprising:
(a) a background comprising an organic light-emitting diode (OLED) display, the background being located adjacent to the sorting area;
(b) an optical sensor spaced from the background for sensing the radiation output from the background and the radiation reflected from and/or transmitted through the products passing through the sorting area, and for generating a radiation signal indicative of the sensed radiation;
(c) a processor coupled to the optical sensor, and
(d) computer-executable instructions for the processor for performing the steps of:
(i) receiving the radiation signal from the optical sensor,
(ii) determining whether the received radiation signal falls outside a predefined range of acceptable signals, and
(iii) if the received radiation signal falls outside the predefined range, identifying the portion of the products corresponding to the radiation signal determined to be outside the predefined range.

33. The apparatus of claim 32, further comprising:
a product separator for separating at least a portion of the products from the products passing through the sorting area; and
computer-executable instructions for the processor for performing the step of actuating the product separator to separate a portion of the products identified as corresponding to the radiation signal determined to be outside the predefined range from the rest of the products.

34. The apparatus of claim 32, wherein the background surrounds the sorting area 360 degrees around.

35. The apparatus of claim 34, wherein the background is configured in a curved shape.

36. The apparatus of claim 34, wherein the background consists of a plurality of sub-backgrounds each comprising a organic light-emitting diode (OLED) display, and the optical sensor consists of a plurality of sub-sensors each being located across the sorting area from the plurality of sub-backgrounds, respectively, for sensing the radiation output from the sub-backgrounds and the radiation reflected from and/or transmitted through the products passing through the sorting area and for generating a radiation signal indicative of the sensed radiation, the processor being coupled to the optical sub-sensors and controlled by computer-executable instructions for performing the steps of:
(i) receiving the radiation signal from each of the optical sub-sensors,
(ii) determining whether the received radiation signal falls outside a predefined range of acceptable signals, and
(iii) if any received radiation signal falls outside the predefined range, identifying the portion of the products corresponding to the radiation signal determined to be outside the predefined range.

37. The apparatus of claim 32, wherein the background surrounds the sorting area.

38. The apparatus of claim 32, wherein the optical sensor comprises a charge-coupled device (CCD) camera.

39. The apparatus of claim 32, wherein the background further comprises a diffusing screen placed on a surface of the display facing the optical sensor.

40. The apparatus of claim 32, wherein the processor is further coupled to the background for controlling an input signal thereto, and the apparatus further comprises:
a feedback system configured to automatically adjust an input signal to the background so that the background's radiation output remains within a desired range.

41. The apparatus of claim 40, wherein the feedback system comprises a spectrometer being configured and arranged to measure a color value of the radiation output from the background, the spectrometer being coupled to the processor, and the processor being controlled by computer-executable instructions for performing the steps of:
(i) receiving the measured color value from the spectrometer,
(ii) referencing a predefined lookup table, which correlates a background input signal to an acceptable color value, to determine whether the received color value of the background equals the acceptable color value, and
(iii) if the received color value does not equal the acceptable color value, adjusting the input signal to the background until the measured color value of the background equals the acceptable color value in the lookup table.

42. The apparatus of claim 41, wherein the spectrometer is further configured to measure an intensity value of the radiation output from the background, and the processor is controlled by computer-executable instructions for performing the further steps of:
(iv) receiving the measured intensity value from the spectrometer,
(v) referencing the predefined lookup table, which correlates a background input signal to an acceptable intensity value, to determine whether the received intensity value of the background equals the acceptable intensity value, and
(vi) if the received intensity value does not equal the acceptable intensity value, adjusting the input signal to the background until the measured intensity value of the background equals the acceptable intensity value in the lookup table.

43. The apparatus of claim 41, wherein the spectrometer is arranged to measure the radiation output from the background via a sensor being arranged to scan the background.

44. The apparatus of claim 40, wherein the optical sensor comprises a charge-coupled device (CCD) camera, and the feedback system comprises the CCD camera being further configured and arranged to measure a color value and an intensity value of the radiation output from the background.

45. The apparatus of claim 32, wherein the processor is further controlled by computer-executable instructions for performing the step of maintaining a rejection rate of the products at a predefined level.

46. The apparatus of claim 45, wherein the processor is further coupled to the background for controlling an input signal thereto, and the step of maintaining a rejection rate of the products comprises the processor adjusting an input signal to the background when the rejection rate is not at the predefined level until the rejection rate is at the predefined level.

47. The apparatus of claim 45, wherein the step of maintaining a rejection rate of the products comprises the processor modifying the range of acceptable signals when the rejection rate is not at the predefined level until the rejection rate is at the predefined level.

48. A color sorting apparatus for sorting products based on their colors, the apparatus defining a sorting station through which the products to be sorted pass, the apparatus comprising:
(a) a background comprising an illuminated display, the background being located adjacent to the sorting station;
(b) an optical sensor located across the sorting station from the background for sensing the radiation from the background and the radiation reflected from and/or transmitted through the products passing through the sorting station, and for generating a radiation signal indicative of the sensed radiation;
(c) a color feedback system configured and arranged to measure a color value of the radiation from the background; and
(d) a processor coupled to the background, the optical sensor, and the color feedback system, the processor being capable of receiving computer-executable instructions for performing the steps of:
(i) receiving the radiation signal from the optical sensor,
(ii) determining whether the received radiation signal falls outside a predefined range of acceptable signals,
(iii) if the received radiation signal falls outside the predefined range, identifying the portion of the products corresponding to the radiation signal determined to be outside the predefined range,
(iv) receiving the measured color value from the color feedback system,
(v) referencing a predefined lookup table, which correlates a background input signal to an acceptable color value, to determine whether the received color value of the background equals the acceptable color value, and
(vi) if the received color value does not equal the acceptable color value, adjusting the input signal to the background until the measured color value of the background equals the acceptable color value in the lookup table.

49. The apparatus of claim 48, further comprising:
a product separator for separating at least a portion of the products from the products passing through the sorting station;
wherein the processor is further controlled by computer-executable instructions for performing the step of actuating the product separator to separate a portion of the products identified as corresponding to the radiation signal determined to be outside the predefined range from the rest of the products.

50. The apparatus of claim 48, wherein the color feedback system comprises a spectrometer, the spectrometer being arranged to measure the radiation from the background via a sensor arranged to scan the background.

51. The apparatus of claim 48, wherein the color feedback system is further configured to measure an intensity value of the radiation output from the background, and the processor is controlled by computer-executable instructions for performing the further steps of:
(iv) receiving the measured intensity value from the color feedback system,
(v) referencing the predefined lookup table, which correlates a background input signal to an acceptable intensity value, to determine whether the received intensity value of the background equals the acceptable intensity value, and
(vi) if the received intensity value does not equal the acceptable intensity value, adjusting the input signal to the background until the measured intensity value of the background equals the acceptable intensity value in the lookup table.

52. The apparatus of claim 51, wherein the optical sensor comprises a charge-coupled device (CCD) camera, and the color feedback system comprises the CCD camera being further configured and arranged to measure a color value and an intensity value of the radiation output from the background.

53. The apparatus of claim 48, wherein the background surrounds the sorting station 360 degrees around.

54. The apparatus of claim 53, wherein the background consists of a plurality of sub-backgrounds each comprising an illuminated display, and the optical sensor consists of a plurality of sub-sensors located across the sorting station from the plurality of sub-backgrounds, respectively, for sensing the radiation from the sub-backgrounds and the radiation reflected from and/or transmitted through the products passing through the sorting station and for generating a radiation signal indicative of the sensed radiation, the processor being coupled to the optical sub-sensors and controlled by computer-executable instructions for performing the steps of:
(i) receiving the radiation signal from each of the optical sub-sensors,
(ii) determining whether the received radiation signal falls outside a predefined range of acceptable signals, and
(iii) if any received radiation signal falls outside the predefined range, identifying the portion of the products corresponding to the radiation signal determined to be outside the predefined range.

55. The apparatus of claim 48, wherein the optical sensor comprises a charge-coupled device (CCD) camera.

56. The apparatus of claim 48, wherein the background further comprises a diffusing screen placed on a surface of the display facing the optical sensor.

57. A color sorting apparatus for sorting products based on their colors, the apparatus defining a sorting area through which the products to be sorted pass, the apparatus comprising:
(a) a background comprising an illuminated display, the background being located adjacent to the sorting area;
(b) an optical sensor located across the sorting area from the background for sensing the radiation from the background and the radiation reflected from and/or transmitted through the products passing through the sorting area, and for generating a radiation signal indicative of the sensed radiation; and
(c) a processor coupled to the optical sensor, the processor being capable of receiving computer-executable instructions for performing the steps of:
(i) receiving the radiation signal from the optical sensor,
(ii) determining whether the received radiation signal falls outside a predefined range of acceptable signals,
(iii) if the received radiation signal falls outside the predefined range, identifying the portion of the products corresponding to the radiation signal determined to be outside the predefined range, and
(iv) maintaining a rejection rate of the products at a predefined level.

58. The apparatus of claim 57, wherein the processor is further coupled to the background for controlling an input signal thereto, and the step of maintaining a rejection rate of the products comprises the processor adjusting an input signal to the background when the rejection rate is not at the predefined level until the rejection rate is at the predefined level.

59. The apparatus of claim 57, wherein the step of maintaining a rejection rate of the products comprises the processor modifying the range of acceptable signals when the rejection rate is not at the predefined level until the rejection rate is at the predefined level.

60. The apparatus of claim 57, further comprising:
a product separator for separating at least a portion of the products from the products passing through the sorting area;
wherein the processor is further controlled by computer-executable instructions for performing the step of actuating the product separator to separate a portion of the products identified as corresponding to the radiation signal determined to be outside the predefined range from the rest of the products.

61. The apparatus of claim 57, wherein the background surrounds the sorting area 360 degrees around.

62. The apparatus of claim 61, wherein the background consists of a plurality of sub-backgrounds each comprising an illuminated display, and the optical sensor consists of a plurality of sub-sensors located across the sorting area from the plurality of sub-backgrounds, respectively, for sensing the radiation from the sub-backgrounds and the radiation reflected from and/or transmitted through the products passing through the sorting area and for generating a radiation signal indicative of the sensed radiation, the processor being coupled to the optical sub-sensors and controlled by computer-executable instructions for performing the steps of:
(i) receiving the radiation signal from each of the optical sub-sensors,
(ii) determining whether the received radiation signal falls outside a predefined range of acceptable signals, and
(iii) if any received radiation signal falls outside the predefined range, identifying the portion of the products corresponding to the radiation signal determined to be outside the predefined range.

63. The apparatus of claim 57, wherein the optical sensor comprises a charge-coupled device (CCD) camera.

64. The apparatus of claim 57, wherein the background further comprises a diffusing screen placed on a surface of the display facing the optical sensor.

65. A method of sorting products based on their colors, the method comprising:
(a) providing a color sorting apparatus, the apparatus defining a sorting area through which the products to be sorted pass, the apparatus comprising:
(i) a background comprising an light-generating display, the background being located adjacent to the sorting area,
(ii) an optical sensor located across the sorting area from the background for sensing the radiation output from the background and the radiation reflected from and/or transmitted through the products passing through the sorting area, and for generating a radiation signal indicative of the sensed radiation,
(iii) a color feedback system configured and arranged to measure a color value of the radiation output from the background, and
(iv) a processor coupled to the background, the optical sensor, and the feedback system;
(b) passing the products to be sorted through the sorting area of the apparatus;
(c) using the processor, determining whether the radiation signal generated by the optical sensor falls outside a predefined range of acceptable signals, and if so, identifying the portion of the products corresponding to the radiation signal determined to be outside the predefined range; and
(d) using the processor, determining whether the color value of the background measured by the feedback system equals a predefined acceptable color value, and if not, adjusting an input signal to the background until the measured color value of the background equals the acceptable color value.

66. The method of claim 65, wherein the color feedback system comprises a spectrometer.

67. The apparatus of claim 65, wherein the color feedback system is further configured to measure an intensity value of the radiation output from the background, and the processor is controlled by computer-executable instructions for performing the further steps of:
(iv) receiving the measured intensity value from the color feedback system,
(v) referencing the predefined lookup table, which correlates a background input signal to an acceptable intensity value, to determine whether the received intensity value of the background equals the acceptable intensity value, and
(vi) if the received intensity value does not equal the acceptable intensity value, adjusting the input signal to the background until the measured intensity value of the background equals the acceptable intensity value in the lookup table.

68. A method of sorting products based on their colors, the method comprising:
(a) providing a color sorting apparatus, the apparatus defining a sorting area through which the products to be sorted pass, the apparatus comprising:
(i) a background comprising a light-generating display, the background being located adjacent to the sorting area,
(ii) an optical sensor located across the sorting area from the background for sensing the radiation output from the background and the radiation reflected from and/or transmitted through the products passing through the sorting area, and for generating a radiation signal indicative of the sensed radiation, and
(iii) a processor coupled to the optical sensor;
(b) passing the products to be sorted through the sorting area of the apparatus;
(c) using the processor, determining whether the radiation signal generated by the optical sensor falls outside a predefined range of acceptable signals, and if so, identifying the portion of the products corresponding to the radiation signal determined to be outside the predefined range; and
(d) using the processor, maintaining a rejection rate of the products at a predefined level.

69. The method of claim 68, wherein the processor is further coupled to the background for controlling an input signal thereto, and the step of maintaining a rejection rate of the products comprises the processor adjusting an input signal to the background when the rejection rate is not at the predefined level until the rejection rate is at the predefined level.

70. The method of claim 68, wherein the step of maintaining a rejection rate of the products comprises the processor modifying the range of acceptable signals when the rejection rate is not at the predefined level until the rejection rate is at the predefined level.
